(19) United States
(12) Patent Application Publication
(10) Pub. No.: US 2010/0211630 A1
(43) Pub. Date: Aug. 19, 2010

(54) METHOD FOR TRANSMITTING DATA TO A FIELD DEVICE IN AUTOMATED TECHNOLOGY, IN PARTICULAR AUTOMATED PROCESS TECHNOLOGY

(75) Inventors: Nicolai Fink, Aesch (DE); Markus Rufe-Nacht, Dornach (CH)

Correspondence Address: BACON & THOMAS, PLLC, 625 SLATERS LANE, FOURTH FLOOR, ALEXANDRIA, VA, 22314-1176, US

(73) Assignee: Endress + Hauser Flowtec AG, Reinach (CH)

(21) Appl. No.: 12/450,990

(22) PCT Filed: May 6, 2008
(86) PCT No.: PCT/EP2008/055570

§ 371 Date: Mar. 31, 2010

(30) Foreign Application Priority Data
May 8, 2007 (DE) 10 2007 022 006.7

(51) Int. Cl. G06F 15/16

(52) U.S. Cl. 709/203; 709/206

(57) ABSTRACT

In a method for transmitting data to a field device of automation technology, especially process automation technology, data are made available in a server computer unit connected with a network. Assigned in the server computer unit to individual field devices are electronic mail boxes with an electronic mailing addresses. Data necessary for an update are transmitted as electronic mail from the server computer unit to the individual field devices.

The invention relates to a method for transmitting data to a field device of automation technology, in particular process automation technology.

In automation technology, in particular process automation technology, field devices are often used that serve to register and/or influence process variables. Examples of such field devices are fill level measuring devices, mass flow meters, pressure and temperature measuring devices etc., which, as sensors, register the corresponding process variables, fill level, flow, pressure and/or temperature.

Actuators serve to influence process variables; for instance, as valves, they influence the flow of a fluid in a pipeline section, or as pumps, they influence the fill level in a container.

A large number of such field devices are manufactured and sold by the firm, Endress+Hauser.

As a rule, field devices in modern automation technology plants are connected via communication systems (HART, Profibus, Foundation Fieldbus, etc.) with superordinated units (e.g. control systems or control units). These superordinated units serve, among other things, for process control, process visualizing, process monitoring as well as for start-up of the field devices. Units, which are directly connected to a field device and which serve for communication with the superordinated units (e.g. remote I/Os, gateways, linking devices), are generally also referred to as field devices.

In part, fieldbus systems are integrated in enterprise networks, which work on the basis of Ethernet. Therewith, process or field device data can be accessed from various areas of an enterprise.

For worldwide communication, the company networks can also be connected with public networks, e.g. the Internet.

For servicing the field devices, corresponding operating programs are necessary.

These operating programs can run self-sufficiently in a superordinated unit (FieldCare, Endress+Hauser; Pactware; AMS, Emerson; Simatic PDM, Siemens) or, however, also, they can be integrated in control system applications (Simatic PCS7, Siemens; ABB Symphony, Delta V, Emerson).

For safe process control, a continuous updating of the field devices is necessary as regards parameter values or software programs (firmware), which run in the field devices.

Modern field devices often have a standardized fieldbus interface for communication with an open fieldbus system and/or a proprietary interface for manufacturer-specific communication with a servicing unit. Frequently, the servicing units are portable computers (laptops, Palms, etc.) as such are generally known in the consumer electronics field (office and home computers)

The updating of individual field devices can occur on the one hand via the fieldbus system of a control system, or via the servicing interface on-site with a servicing unit. For this, corresponding program applications (tools) are known.

Especially, inputting a new software version into a field device is performed, today, most often on-site, in other words directly at the field device. In such case, it cannot be excluded that a service technician loads an incorrect or outdated software version, or that errors occur for the service technician in the inputting of parameter values.

An object of the present invention is to provide a method for transmitting data to a field device of automation technology, especially process automation technology, which does not have the above named disadvantages, which is especially simple and safely put into practice.

This object is achieved by the following method as set forth in claim 1:

Method for transmitting data to a field device of automation technology, especially process automation technology, wherein data are made available in a computer server unit connected with a network, characterized in that associated with the field device in the computer server unit is an electronic mail box with an electronic mailing address, and data are transmitted as electronic mail from the computer server unit to the field device.

An essential idea of the invention is to associate with a field device an electronic mailing address (email address) and to transmit data, which are required for updating the relevant field device, as electronic mail to the field device. In this way, extensive manual inputting by a service technician is no longer necessary for updating.

Errors in the case of updating are excluded with great certainty.

Advantageous further developments of the invention are set forth in the dependent claims.

The invention will now be explained in greater detail on the basis of an embodiment illustrated in the drawing, the sole figure of which shows as follows:

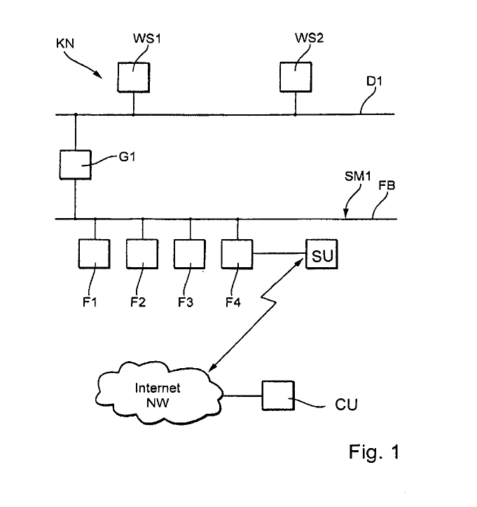

FIG. 1 communication network of automation technology.

FIG. 1 shows a communication network KN of automation technology, especially of process automation-technology, in greater detail. Connected to a data bus D1 are a number of computer units (workstations) WS1, WS2. These computer units serve as superordinated units (control systems, or control units) for process visualizing, process monitoring and for engineering as well as for servicing and monitoring field devices. The data bus D1 works e.g. according to the Profibus DP-standard or according to the HSE (High Speed Ethernet) standard of Foundation Fieldbus. Via a gateway G1, which is also referred to as linking device or as segment coupler, data bus D1 is connected with a fieldbus segment SM1. Fieldbus segment SM1 is composed of a plurality of field devices F1, F2, F3, F4 that are connected with one another via a fieldbus FB. The field devices F1, F2, F3, F4, involve both sensors as well as actuators. Fieldbus FB works correspondingly after one of the known fieldbus standards, Profibus, Foundation Fieldbus or HART.

The method of the invention will now be explained in greater detail.

As an example, field device F4 is selected. The software program (firmware) of field device F4 is to be updated.

The service technician connects to the field device F4 a service unit SU (e.g. a laptop), on which a corresponding operating program (e.g. FieldCare of the firm, Endress+Hauser) is installed. The connection can occur e.g. via a corresponding service interface on the field device F4. The service technician issues an updating instruction to the field device.

Thereupon, the field device, which functions as client (email client), sends an electronic mail (email) to a server computer unit CU (email server), which is connected via a network NW (e.g. the Internet) to the service unit SU.

If the field device F4 is e.g. a flow measuring device Promag 55 of the firm, Endress+Hauser Flowtec, the mailing address of the server computer unit CU could read update@promag55.flotec.endress.com. The server unit CU is either located directly at the manufacturer of the field device or is directly accessed by the manufacturer. In this way, the complete competence of the manufacturer, regarding updates and particular parameter values, is available. The electronic mail contains a request for updating and a corresponding password, which is stored in the field device F4.

The sender address, i.e. the electronic mailing address of the field device F4, could read e.g. 123456789@promag55.devices.flotec.endress.com, wherein the number 123456789 represents of the serial-number of the field device F4. On the basis of this serial number, the field device F4 can be identified in the server computer unit CU.

After the correctness of the password has been checked, the server computer unit CU or another computer unit is searched for program updates for the field device of concern.

If a program update is available, this is provided as an electronic mail transmission for the field device of concern in an electronic mail box (POP-account).

From the field device F4, the electronic mail box is checked. When a mail is present, such is downloaded to the field device. Thus the program update can get to the field device and can be loaded via a corresponding mechanism (boot-load mode).

In a similar manner parameter values naturally can also be transmitted to a field device.

If the field device has a direct connection to the network (Internet), the service unit SU also can be dispensed with.

The updates can also involve user-specific parameter values, diagnostic values, or user specific programs, which are not necessarily program updates.

1-5. (canceled)

6. A method for transmitting data to a field device of automation technology, including a server computer unit connected with a network and field devices, comprising the steps of:
providing an electronic mailbox in the server computer unit with an electronic mailing address; and
transmitting data as electronic mail from the server computer unit to the field devices.

7. The method as claimed in claim 6, wherein:
the field devices are connected via a service unit, or directly, with the network.

8. The method as claimed in claim 6, wherein:
an electronic mail box application and an electronic mailing address are stored in the field device.

9. The method as claimed in claim 8, wherein:
an identifier for safe identification of the field device during electronic mail traffic is stored in the field devices.

10. The method as claimed in claim 6, wherein:
an electronic mail box is provided in the server computer unit for storing electronic mail for the field devices.
